(19) United States
(12) Patent Application Publication
(10) Pub. No.: US 2026/0356205 A1
(43) Pub. Date: Nov. 12, 2026

(54) ELECTRIC POWER SUPPLY SYSTEM FOR A VEHICLE

(71) Applicant: Schaeffler Technologies AG & Co. KG, Herzogenaurach (DE)

(72) Inventors: Damien VERDIER, Toulouse (FR); Jérôme LACHAIZE, Toulouse (FR); Nicolas LETO, Toulouse (FR)

(21) Appl. No.: 19/124,017

(22) PCT Filed: Nov. 21, 2023
(86) PCT No.: PCT/EP2023/082460

§ 371 Date: Apr. 24, 2025

(30) Foreign Application Priority Data
Nov. 28, 2022 (FR) FR2212377

(51) Int. Cl. B60L 15/00; B60L 1/00; H02J 7/34

(52) U.S. Cl. CPC B60L 15/007; B60L 1/00; H02J 7/34; B60L 2210/10; H02J 2207/20

(57) ABSTRACT

The invention relates to an electric power supply system (1) for an electric or hybrid vehicle, the vehicle comprising an electric power supply bus (HV+, HV−), said system (1) comprising:
a) a DC-DC voltage converter (50),
b) at least two power supply cells (10, 20, 30), each comprising:
   i. a rectifier (r1, r2, r3),
   ii. a battery (B1, B2, B3),
      the power supply system (1) is configured to operate in an operating mode in which:
the DC-DC converter (50) is disconnected from the power supply bus (HV+, HV−) and from each power supply cell (10, 20, 30),
only one of the power supply cells (10, 20, 30) is supplied with electrical energy,
the set of batteries (B1, B2, B3) is connected in series,
the power supply bus (HV+, HV−) is supplied with power from electrical energy provided by the set of batteries (B1, B2, B3) in series.

### TECHNICAL FIELD

The invention relates to the field of hybrid or electric vehicles, and more specifically to an electric power supply system for a hybrid or electric vehicle.

### PRIOR ART

In a known manner, an electric or hybrid vehicle comprises an electric machine for propulsion of the vehicle, as well as a storage battery able to be connected to the electric machine. An inverter is connected between the battery and the electric machine and makes it possible to convert the DC voltage provided by the battery into an AC voltage, in particular three-phase AC voltage, in order to supply power to each phase of the electric machine.

The vehicle also comprises an internal electric power supply network, which makes it possible to supply power to the electrical equipment of the vehicle (for example the windscreen wipers, the headlights, the warning lights of the dashboard, etc.).

The voltage provided by the network is, for example, 12 or 14 V.

The vehicle also comprises an auxiliary battery able to supply power to the network and a DC-DC voltage converter connected between the auxiliary battery and the battery in order to recharge the auxiliary battery. The configuration of the auxiliary batteries and associated converters in a vehicle depends on the type of vehicle, which requires significant adaptation efforts.

In addition, each battery is in reality made up of a set of battery cells statically connected to one another. The charge level of each battery depends on the state of charge of each cell. However, the cells may not all have identical electrical and energy characteristics. The dimensioning of each battery must therefore take into consideration aging phenomena and the performance of each cell, which is restrictive.

Moreover, the dimensioning of the components of the converter and of the inverter is carried out such that the voltage provided by the converter and the inverter are each defined over a wide range of voltages. Therefore, since the dimensioning of each of these elements is not carried out for an optimal operating voltage, this may cause losses after each conversion implemented by the converter or the inverter, on the one hand, and difficulty in accurately controlling the output power of each converter and/or inverter, on the other hand.

There is therefore the need for a solution which makes it possible to overcome, at least in part, the drawbacks described above.

### SUMMARY OF THE INVENTION

To this end, the invention relates to an electric power supply system for an electric or hybrid vehicle, the vehicle comprising an electric power supply bus able to supply power to electrical equipment installed in the vehicle, said system comprising:
a) a DC-DC voltage converter,
b) at least two power supply cells, each comprising:
   i) a rectifier able to provide an AC voltage from a DC voltage and vice versa,
   ii) a battery, which is electrically connected to the rectifier, able to operate in a discharge mode in which the battery is able to provide a first DC voltage, and able to operate in a charge mode in which the battery is able to recharge from a DC voltage,
   iii) a switching cell comprising switches able to connect the battery to the converter,
c) a set of switches able to connect the battery of a power supply cell to the battery of the neighboring power supply cell in order to connect the batteries in series,
d) a second set of switches able to connect the set of batteries connected in series to the electric power supply bus,
e) a control unit configured to control the first set of switches, the second set of switches and each switching cell,
the power supply system is configured to operate in an operating mode in which:
   a) the DC-DC converter is disconnected from the power supply bus and from each power supply cell,
   b) only one of the power supply cells is supplied with electrical energy,
   c) the first set of switches is closed in order to connect the set of batteries in series,
   d) the second set of switches is closed in order to supply power to the power supply bus from the electrical energy provided by the set of batteries.

The power supply system therefore makes it possible to supply power to the power supply bus only from the electrical energy provided by the batteries connected in series, and not from the DC-DC converter. For example, with a first battery operating in the charge mode, the other battery or batteries of the other power supply modules makes/make it possible to provide additional electrical energy to that already provided by the battery being charged, and required to correctly supply power to the power supply bus. In other words, the other battery or batteries provides/provide an amount of electrical energy that is dependent on the state of charge and on the amount of electrical energy provided by the battery being charged, and on the electrical energy required by the power supply bus.

More preferably, the power supply system comprises a connection module able to electrically connect each power supply cell to an electric power supply network able to provide an AC voltage or to an item of electrical equipment that is external to the vehicle and able to be supplied with power from an AC voltage:
a) if the AC voltage provided by the power supply network, or if the voltage required to supply power to the electrical equipment, is single-phase, the connection module is able to connect the single-phase voltage to at least one power supply cell,
b) if the AC voltage provided by the power supply network, or if the voltage required to supply power to the electrical equipment, is three-phase, the connection module is able to connect each phase of said voltage to a power supply cell.

The power supply system therefore makes it possible for each battery to be charged from a three-phase or single-phase AC voltage.

More preferably, each power supply cell comprises a coil connected to the rectifier, on the one hand, and to the switching cell, on the other hand. Each coil makes it possible to control the current by regulating the voltage across the terminals of each battery.

More preferably, the power supply system comprises three power supply cells. For a three-phase AC voltage, it is practical to have one power supply cell per phase of said AC voltage.

Advantageously, the connection module comprises:
a. a first connection terminal electrically connected to the first power supply cell,
b. a second connection terminal,
c. a third connection terminal,
d. a first switch able to connect the second power supply cell to the first connection terminal or to the second connection terminal,
e. a second switch able to connect the third power supply cell to the first connection terminal or to the third connection terminal.

Therefore, if the voltage provided on the first connection terminal is single-phase and supplies power to the first power supply cell, said voltage may also supply power to the second and the third power supply cell. Moreover, if the voltage provided on the first connection terminal is three-phase: each phase is connected to a connection terminal, which is itself connected to a power supply cell. Therefore, a battery is charged from a single-phase or a three-phase voltage.

More preferably, when the phase of a single-phase AC voltage is connected to the first connection terminal, the first switch and the second switch of the connection module are configured to:
a) connect the first connection terminal to the second power supply cell and the third power supply cell, or
b) disconnect the first connection terminal from the second power supply cell and from the third power supply cell.

It is therefore possible to supply power to each power supply cell from a single-phase voltage. The single-phase voltage may therefore be alternately connected to each of the power supply cells, in order to balance the state of charge of all the batteries, and to not always charge/discharge the same battery.

The invention also relates to a motor vehicle comprising an electric power supply bus able to supply power to electrical equipment installed in the vehicle, and an electric power supply system as presented above.

The invention also relates to a method for controlling an electric system as presented above, said method being implemented by the control unit and comprising the steps of:
a) disconnecting the DC-DC converter from the power supply bus and from each power supply cell,
b) supplying one of the power supply cells with electrical energy,
c) closing each switch of the first set of switches in order to connect the set of batteries in series,
d) closing each switch of the second set of switches in order to supply power to the power supply bus from the electrical energy provided by the set of batteries.

### DESCRIPTION OF THE DRAWINGS

Other features and advantages of the invention will become more clearly apparent upon reading the following description. This description is purely illustrative and should be read with reference to the appended drawings, in which:

FIG. 1 is a diagram showing the power supply system according to the invention.

FIG. 2 is a circuit diagram showing the first operating mode of the power supply system according to FIG. 1.

FIG. 3 shows the variation in the supply voltage provided by each of the power supply cells of the power supply system according to FIG. 1.

### DESCRIPTION OF THE EMBODIMENTS

### Vehicle

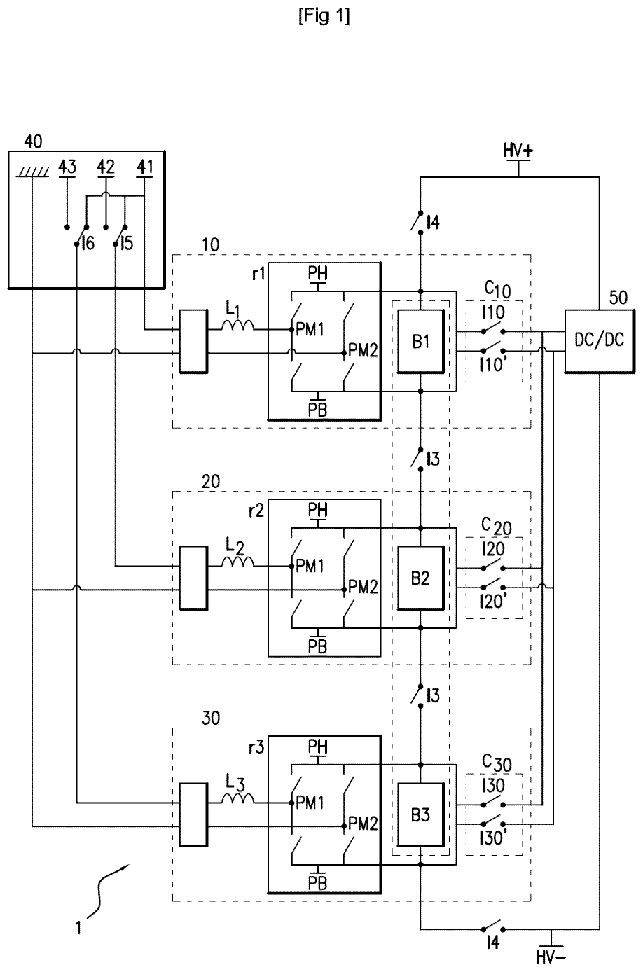

With reference to FIG. 1, a vehicle according to the invention will now be described. In particular, the vehicle comprises an electric power supply bus HV. The electric power supply bus HV is able to provide electrical energy to various items of electrical equipment embedded in the vehicle. Even more specifically, the power supply bus comprises a positive terminal HV+and a negative terminal HV−.

The vehicle also comprises an electric power supply system 1.

### Power Supply System

With reference to FIG. 1, the power supply system 1 comprises at least two power supply cells 10, 20, 30, a connection module 40, a DC-DC voltage converter 50 and a control unit (not shown in the figures).

The DC-DC converter 50 is intended to be electrically connected between the positive terminal HV+and the negative terminal HV− of the power supply bus.

Preferably, the power supply system 1 comprises a first power supply cell 10, a second power supply cell 20 and a third power supply cell 30. Each power supply cell 10, 20, 30 is able to convert an AC voltage into a DC voltage.

### Power Supply Cell 10, 20, 30

Each power supply cell 10, 20, 30 comprises a rectifier r1, r2, r3, a battery B1, B2, B3 and a switching cell C₁₀, C₂₀, C₃₀.

More specifically, the rectifier r1, r2, r3 of each power supply cell 10, 20, 30 is said to be bidirectional. In other words, each rectifier r1, r2, r3 is able to provide an AC voltage from a DC voltage and vice versa.

Each rectifier r1, r2, r3 comprises two input terminals and two output terminals.

More specifically, in the present case, each rectifier r1, r2, r3 comprises a first switch connected between a high point PH and a first midpoint PM1, a second switch connected between the first midpoint PM1 and a low point PB, a third switch connected between the high point PH and a second midpoint PM2 and a fourth switch connected between the second midpoint PM2 and the low point PB. The two input terminals of each rectifier r1, r2, r3 designate the first midpoint PM1 and the second midpoint PM2. The two output terminals designate the high point PH and the low point PB.

The battery B1, B2, B3 of each power supply cell 10, 20, 30 is able to operate in a discharge mode in which the battery B1, B2, B3 is able to provide a DC voltage. The value of the DC voltage provided by each battery B1, B2, B3 is furthermore controllable. Moreover, the battery B1, B2, B3 of each power supply cell 10, 20, 30 is also able to operate in a charge mode in which the battery B1, B2, B3 recharges.

In addition, the battery B1, B2, B3 of each power supply cell 10, 20, 30 is connected to the corresponding rectifier r1, r2, r3. More specifically, each battery B1, B2, B3 is connected between the two output terminals of the corresponding rectifier r1, r2, r3.

The switching cell C₁₀, C₂₀, C₃₀ of each power supply cell 10, 20, 30 is able to connect the battery B1, B2, B3 to the DC-DC converter 50. In other words, the switching cell C₁₀, C₂₀, C₃₀ is connected to the battery B1, B2, B3, on the one hand, and to the DC-DC converter 50, on the other hand.

Each switching cell C₁₀, C₂₀, C₃₀ comprises a first switch I10, I20, I30 and a second switch I10′, I20′, I30′.

The first switch I10, I20, I30 of each power supply cell 10, 20, 30 makes it possible to connect a first terminal of the battery B1, B2, B3 to a terminal of the DC-DC converter 50.

The second switch I10′, I20′, I30′ of each power supply cell 10, 20, 30 makes it possible to connect a second terminal of the battery B1, B2, B3 to a second terminal of the DC-DC converter 50.

### Coils

In addition, each power supply cell 10, 20, 30 comprises a coil L1, L2, L3 connected to the input of the rectifier r1, r2, r3, in other words, a coil is connected to the rectifier r1, r2, r3, on the one hand, and intended to be connected to an AC voltage, on the other hand.

The power supply system 1 also comprises a first set of switches I3 and a second set of switches I4.

### First Set of Switches I3

The first set of switches I3 is able to connect the battery B1, B2, B3 of a power supply cell 10, 20, 30 to the battery B1, B2, B3 of the neighboring power supply cell 10, 20, 30 in order to connect the batteries B1, B2, B3 in series.

For this purpose, the first set of switches I3 comprises:
a. a switch connected to the battery B1 of the first power supply cell C₁₀, on the one hand, and to the battery B2 of the second power supply cell C₂₀, on the other hand,
b. a switch connected to the battery B2 of the second power supply cell C₂₀, on the one hand, and to the battery B3 of the third power supply cell C₃₀, on the other hand.

Therefore, the batteries B1, B2, B3 may be connected in series; it is then said that the batteries form a power supply branch.

### Second Set of Switches I4

The second set of switches I4 makes it possible to connect the battery B1 of the first power supply cell C₁₀ to the power supply bus HV, in particular in order to connect the branch of series-connected batteries B1, B2, B3 to the power supply bus HV.

### Connection Module 40

The connection module 40 is able to be connected to an electric power supply network or to an item of electrical equipment external to the vehicle, on the one hand, and to at least one of the power supply cells 10, 20, 30, on the other hand.

When the connection module 40 is connected to a power supply network, the power supply network then makes it possible to recharge at least one battery B1, B2, B3 of the at least one power supply cell 10, 20, 30 connected to said connection module 40.

When the connection module 40 is connected to an item of electrical equipment, at least one battery B1, B2, B3 of the at least one power supply cell 10, 20, 30 connected to said connection module 40 makes it possible to supply electrical energy to said equipment.

More specifically, if the AC voltage provided by the power supply network, or if the voltage required to supply power to the electrical equipment, is single-phase, the connection module 40 is able to connect the single-phase voltage to at least one power supply cell 10, 20, 30. If the AC voltage provided by the power supply network, or if the voltage required to supply power to the electrical equipment, is three-phase, the connection module 40 is able to connect each phase of said AC voltage to a power supply cell 10, 20, 30 of its own.

Even more specifically, the connection module 40 comprises a first connection terminal 41, a second connection terminal 42 and a third connection terminal 43.

When the AC voltage provided by the power supply network, or when the voltage required to supply power to the electrical equipment, is three-phase, each phase of said voltage is connected to a connection terminal 41, 42, 43 of its own. Conversely, when the AC voltage provided by the power supply network, or when the voltage required to supply power to the electrical equipment, is single-phase, the phase of said voltage is connected to the first connection terminal 41.

In addition, the first connection terminal 41 is connected to the first switching cell 10, more specifically to an input terminal of the rectifier r1 of the first switching cell 10.

The connection module 40 also comprises:
a) a first switch I5 configured to:
   i) in a first position: connect the first connection terminal 41 to the second power supply cell 20, and more specifically to an input terminal of the rectifier r2 of the second power supply cell 20,
   ii) in a second position: connect the second connection terminal 42 to the second power supply cell 20, and more specifically to an input terminal of the rectifier r2 of the second power supply cell 20,
b) a second switch I6 configured to:
   i) in a first position: connect the first connection terminal 41 to the third power supply cell 30, and more specifically to an input terminal of the rectifier r3 of the third power supply cell 30,
   ii) in a second position: in particular when the AC voltage provided by the power supply network, or when the voltage required to supply power to the electrical equipment, is three-phase, connect the third connection terminal 43 to the third power supply cell 30, and more specifically to an input terminal of the rectifier r3 of the third power supply cell 30.

In addition, the connection module 40 is also connected to the neutral line of the AC voltage and the connection module 40 is configured to connect the neutral line to the second input terminal of each rectifier r1, r2, r3.

Moreover, each power supply cell 10, 20, 30 may also comprise an EMC (electromagnetic compatibility) filter connected between each rectifier r1, r2, r3 and the connection module 40.

The control unit (not shown in the figures) is configured to control the opening and the closing of the switches I5, I6 of the connection module 40, of the first set of switches I3, of the second set of switches I4 and of each switch of each switching cell C₁₀, C₂₀, C₃₀ and of each rectifier r1, r2, r3. The control unit is also able to control the voltage provided and generated by each battery B1, B2, B3 in order, for example, to regulate the current in the inductors L1, L2, L3 or to regulate the voltage to be provided to the DC-DC converter 50.

### Operating Modes

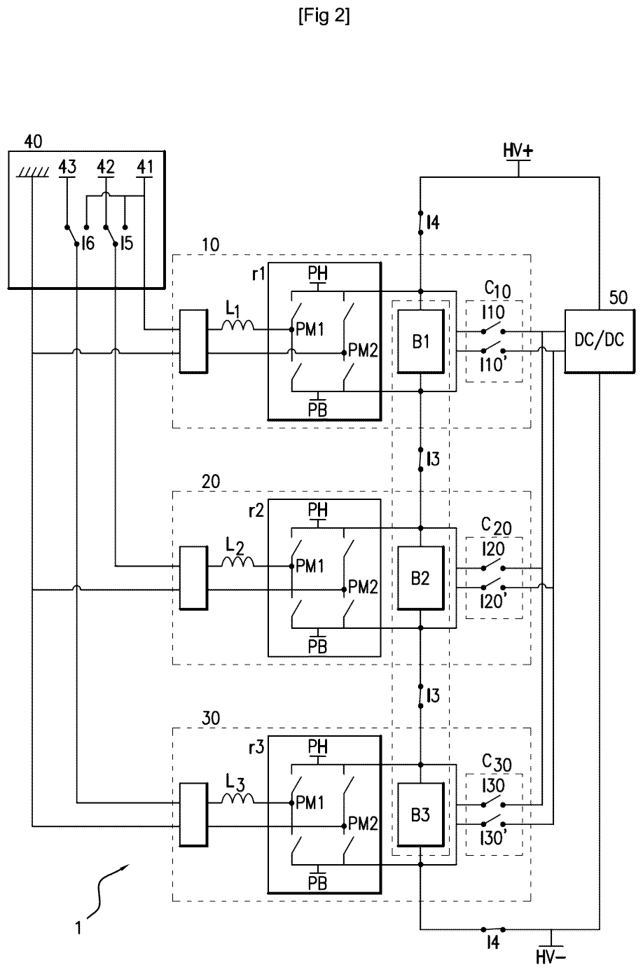

One of the operating modes of the power supply system 1 as presented above will now be described with reference to FIG. 2. It is recalled that the control unit is responsible for controlling each of the switches in order to implement the operating mode described below.

The control unit also controls the disconnection between the DC-DC converter 50 and the power supply bus HV.

The control unit also controls the closing of each switch of the first set of switches I3 in order to connect the set of batteries B1, B2, B3 in series. Similarly, the control unit controls the closing of each switch of the second set of switches I4 in order to supply power to the power supply bus from the electrical energy provided by the set of batteries B1, B2, B3.

In addition, the switches of each switching cell C₁₀, C₂₀, C₃₀ are opened so as to disconnect the set of power supply cells 10, 20, 30 from the DC-DC converter 50.

Finally, the control unit controls the connection module 40 in such a way that a single power supply cell 10, 20, 30 of the power supply system 1 is connected to a (single-phase or three-phase) voltage via the connection module 40. For example, here, only the first power supply cell 10 is supplied with electrical energy, and only the first battery B1 is in charge mode or in discharge mode.

Therefore, the operating mode described above makes it possible to supply power to the power supply bus only from the batteries B1, B2, B3 connected in series, and no longer via the DC-DC converter 50.

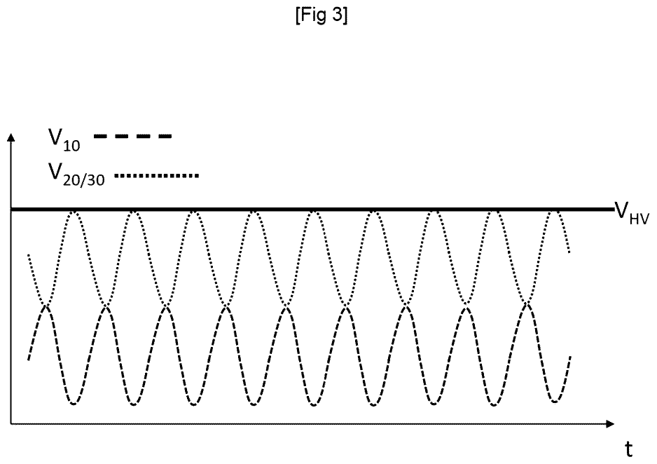

For example, with reference to FIG. 3, the first power supply cell 10 is connected to the connection module 40 and provides a rectified voltage V₁₀, which may, for example, have a sinusoidal portion. The second power supply cell 20 and the third power supply cell 30 each provide a power supply voltage V_{20/30} in order to compensate for the sinusoidal portion of the rectified voltage V₁₀ provided by the first power supply cell 10, on the one hand, and to obtain a DC voltage value V_{HV} required to supply power to the power supply bus, on the other hand. In other words, the second power supply cell 20 and the third power supply cell 30 make it possible here to compensate for the variations in the voltage provided by the first power supply cell 10 so that the voltage provided by the set of power supply cells 10, 20, 30 is a DC voltage and makes it possible to supply power to the power supply bus.

1. An electric power supply system (1) intended to be embedded in an electric or hybrid vehicle, the vehicle comprising an electric power supply bus (HV+, HV−) able to supply power to electrical equipment installed in the vehicle, said system (1) comprising:
a) a DC-DC voltage converter (50),
b) at least two power supply cells (10, 20, 30), each comprising:
i) a rectifier (r1, r2, r3) able to provide an AC voltage from a DC voltage and vice versa,
ii) a battery (B1, B2, B3), which is electrically connected to the rectifier (r1, r2, r3), able to operate in a discharge mode in which the battery (B1, B2, B3) is able to provide a first DC voltage, and able to operate in a charge mode in which the battery (B1, B2, B3) is able to recharge from a DC voltage,
iii) a switching cell (C₁₀, C₂₀, C₃₀) comprising switches (I10, I10′, I20, I20′, I30, I30′) able to connect the battery (B1, B2, B3) to the converter (50),
c) a first set of switches (I3) able to connect the battery (B1, B2, B3) of a power supply cell (10, 20, 30) to the battery (B1, B2, B3) of the neighboring power supply cell (10, 20, 30) in order to connect the batteries (B1, B2, B3) in series,
d) a second set of switches (I4) able to connect the set of batteries (B1, B2, B3) connected in series to the electric power supply bus (HV+, HV−),
e) a control unit configured to control the first set of switches (I3), the second set of switches (I4) and each switching cell (C₁₀, C₂₀, C₃₀),
f) a connection module (40) able to electrically connect each power supply cell (10, 20, 30) to an electric power supply network able to provide an AC voltage or to an item of electrical equipment that is external to the vehicle and able to be supplied with power from an AC voltage,
the power supply system (1) is configured to operate in an operating mode in which:
the DC-DC converter (50) is disconnected from the power supply bus (HV+, HV−) and from each power supply cell (10, 20, 30),
only one of the power supply cells (10, 20, 30) is supplied with electrical energy,
the first set of switches (I3) is closed in order to connect the set of batteries (B1, B2, B3) in series,
the second set of switches (I4) is closed in order to supply power to the power supply bus (HV+, HV−) from the electrical energy provided by the set of batteries (B1, B2, B3).

2. The power supply system (1) as claimed in claim 1, in which the connection module (40) is configured to operate as follows:
a) if the AC voltage provided by the power supply network, or if the voltage required to supply power to the electrical equipment, is single-phase, the connection module (40) is able to connect the single-phase voltage to at least one power supply cell (10, 20, 30),
b) if the AC voltage provided by the power supply network, or if the voltage required to supply power to the electrical equipment, is three-phase, the connection module (40) is able to connect each phase of said voltage to a power supply cell (10, 20, 30).

3. The power supply system (1) as claimed in claim 1, in which each power supply cell (10, 20, 30) comprises a coil (L1, L2, L3), connected to the rectifier (r1, r2, r3) and intended to be connected to an AC voltage.

4. The power supply system (1) as claimed in claim 1, comprising three power supply cells (10, 20, 30).

5. The power supply system (1) as claimed in claim 2, in which the connection module (40) comprises:
a) a first connection terminal (41) electrically connected to the first power supply cell (10),
b) a second connection terminal (42),
c) a third connection terminal (43),
d) a first switch (I5) able to connect the second power supply cell (20) to the first connection terminal (41) or to the second connection terminal (42),
e) a second switch (I6) able to connect the third power supply cell (30) to the first connection terminal (41) or to the third connection terminal (43).

6. The power supply system (1) as claimed in claim 5, in which, when the phase of a single-phase AC voltage is connected to the first connection terminal (41), the first switch (I5) and the second switch (I6) of the connection module (40) are configured to:
a) connect the first connection terminal (41) to the second power supply cell (20) and to the third power supply cell (30), or
b) disconnect the first connection terminal (41) from the second power supply cell (20) and from the third power supply cell (30).

7. A motor vehicle comprising an electric power supply bus (HV+, HV−) able to supply power to electrical equipment installed in the vehicle, and an electric power supply system (1) as claimed claim 1.

8. A method for controlling a power supply system (1) as claimed in claim 1, said method being implemented by the control unit and comprising the steps of:
a) disconnecting the DC-DC converter (50) from the power supply bus (HV+, HV−) and from each power supply cell (10, 20, 30),
b) supplying one of the power supply cells (10, 20, 30) with electrical energy,
c) closing each switch of the first set of switches (I3) in order to connect the set of batteries (B1, B2, B3) in series,
d) closing each switch of the second set of switches (I4) in order to supply power to the power supply bus (HV+, HV−) from the electrical energy provided by the set of batteries (B1, B2, B3).
